(19) United States
(12) Patent Application Publication
(10) Pub. No.: US 2016/0244173 A1
(43) Pub. Date: Aug. 25, 2016

(54) THREE POINT AIR BELT

(71) Applicant: Takata Protection Systems, Inc., Pompano Beach, FL (US)

(72) Inventors: MARK EDWARD DEEVEY, Coral Springs, FL (US); MICHAEL H. SCHINDZIELORZ, Kernersville, NC (US)

(73) Assignee: Takata Protection Systems, Inc., Pompano Beach, FL (US)

(21) Appl. No.: 15/143,090

(22) Filed: Apr. 29, 2016

Related U.S. Application Data
(63) Continuation-in-part of application No. 14/516,869, filed on Oct. 17, 2014.
(60) Provisional application No. 61/954,847, filed on Mar. 18, 2014.
(60) Provisional application No. 62/154,367, filed on Apr. 29, 2015.

(51) Int. Cl. B64D 25/06; B64D 25/02

(52) U.S. Cl. CPC B64D 25/06; B64D 25/02; B64D 2201/00

(57) ABSTRACT

The present invention discloses embodiments of an apparatus, systems and related methods for side-facing occupant protection in an aircraft during an abrupt stop—such as in a forward-facing crash event. Embodiments of the present invention disclose a three point air belt that provide superior passenger comfort and retractability, due to inventive construction, by providing enhanced flexibility of the three-point air belt, and more specifically, the shoulder harness portion. The present invention first includes a new airbag material which contributes to the enhanced flexibility, namely, a polyester textile structure treated with a phosphate-phosphonate compound. In further embodiments the material is the coated in a polyurethane mixture. The present invention also includes a new method of compacting the airbag such that it may be disposed in a shoulder harness while remaining substantially unobtrusive and comfortable to a passenger. The invention also includes a new containment material, namely a tubular webbing, to further enhance the flexibility of the shoulder harness over the prior art which generally comprises leather or leather-approximations. The result of the invention also provides enhanced retractability over the prior art, such that the three-point harness may be more easily stowed relative to the prior art.

### CROSS-REFERENCE TO RELATED APPLICATIONS

This U.S. Non-Provisional Patent Application is a continuation-in-part of currently pending U.S. patent application Ser. No. 14/516,869, filed on Oct. 17, 2014, which claims the benefit of U.S. Provisional Patent Application No. 61/954,847, filed on Mar. 18, 2014, now expired, and are incorporated by reference as if fully set forth here. This U.S. Non-Provisional Patent Application also claims the benefit of the currently Pending, U.S. Provisional Patent Application No. 62/154,367, filed on 29 Apr. 2015, and is incorporated by reference as if fully set forth herein.

### STATEMENT REGARDING FEDERALLY SPONSORED RESEARCH OR DEVELOPMENT

None.

### FIELD OF THE INVENTION

This invention relates generally to the field of vehicle restraints and, more specifically, to apparatus, systems and related methods for side-facing occupant protection in an aircraft during an abrupt stop—such as in a forward-facing crash event.

### BACKGROUND

It is known in the art to incorporate restraints in vehicles for occupant safety. It is further known in the art to incorporate airbags and airbag systems in vehicles for occupant safety.

Typically, three-point harnesses—with a portion across the passenger's lap and another portion extending from the lap to up over a shoulder—are deployed to arrest the forward momentum of a passenger's torso, but offer no resistance to the forward momentum of a passenger's head. When seated in a longitudinally-mounted aircraft seat, a passenger's forward momentum will tend to carry the head in a substantially sideways direction, relative to the passenger, toward the front of the aircraft.

The problem here is that the unrestrained acceleration of the passenger's head, relative to the restrained torso, has been shown to cause injuries to the passenger, either due to the acceleration itself (whiplash) or due to the contact of the head with a nearby aircraft structure or other passenger.

Previous attempts to address this problem merely incorporate automotive harnesses and airbag systems. Various differences in vehicle structure, crash impact profile, occupant comfort expectations, and Federal regulations make it undesirable, impractical, or infeasible to merely install an automotive restraint into a side-facing aircraft seat.

Presently known methods of constructing airbags, such as those intended for automotive use, do not conform to Federal Aviation Administration (FAA) flammability regulations, such as Federal Aviation Requirement (FAR) 25.853 for vertical flammability. Uncoated and coated textile structures now in use are based upon automotive industry flammability requirements for airbag fabric. These material are tested based on a horizontal flammability procedure, according to FMVSS302. While it is known in the art to use a typical nylon fabric, coated with liquid silicon rubber, this type of airbag material is non-conforming to FAR 25.853 for vertical flammability. Thus, it may be desirable to construct an airbag out of such materials and coatings as will conform to FAA flammability requirements for use in aircraft.

It would, therefore, be desirable to have an apparatus, system and related method for increasing occupant safety during a sudden acceleration, such as a forward crash event, in a vehicle, such as an aircraft, where the occupant is seated in a lateral—side-facing—orientation relative to the vehicle. It would be further desirable for the apparatus, system and related method to provide superior passenger comfort and belt retractability. Still further, it would be desirable for the materials used to conform to FAA flammability regulations, such as FAR 25.853 for vertical flammability.

While certain aspects of conventional technologies and methods in the relevant art have been discussed to facilitate disclosure of the invention, Applicant in no way disclaims these technical aspects or methods, and it is contemplated that the claimed invention may encompass one or more of the conventional technical aspects or methods discussed herein.

In this specification, where a document, act, or item of knowledge is referred to or discussed, this reference or discussion is not an admission that the document, act, or item of knowledge or any combination thereof was, at the priority date, publicly available, known to the public, part of common general knowledge, or otherwise constitutes prior art under the applicable statutory provisions; or is known to be relevant to an attempt to solve any problem with which this specification is concerned.

### SUMMARY

In this specification and in the appended claims and drawings, words and phrases have the meanings commonly attributed to them in the relevant art except as otherwise specified herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In view of the foregoing, an embodiment of the invention is directed toward a three-point harness, including an airbag integral therewith, designed to be deployed in longitudinally mounted, or side-facing, seats in aircraft. Embodiments of the present invention provide an airbag, mounted in the shoulder portion of the harness, which can inflate to arrest such sideways motion of a passenger's head in the event of an abrupt stop of the aircraft.

While some variations of seatbelt-mounted airbags exist in the art, the present invention provides superior passenger comfort and retractability, due to inventive construction, by providing enhanced flexibility of the three-point air belt, and more specifically, the shoulder harness portion. The present invention first includes a new airbag material which contributes to the enhanced flexibility, namely, a polyester textile structure treated with a phosphate-phosphonate compound. In further embodiments the material is then coated in a polyurethane mixture. The present invention also includes a new method of compacting the airbag such that it may be disposed in a shoulder harness while remaining substantially unobtrusive and comfortable to a passenger. The invention also includes a new containment material, namely a tubular webbing, to further enhance the flexibility of the shoulder harness over the prior art which generally comprises leather or leather-approximations. The result of the invention also provides enhanced retractability over the prior art, such that the three-point harness may be more easily stowed relative to the prior art.

### BRIEF DESCRIPTION OF THE DRAWINGS

These and other features, aspects, and advantages of the present invention will become better understood with regard to the following description, appended claims, and accompanying drawings where:

FIG. 1 illustrates a three point air belt in an un-inflated state, according to an embodiment herein, depicted in a typical installation environment, indicated in dashed lines for reference;

FIG. 2 illustrates a three point air belt in an inflated state, according to an embodiment herein, depicted in a typical installation environment, indicated in dashed lines for reference; and

FIG. 3 illustrates a three point air belt, according to an embodiment herein, depicted in a typical installation environment, indicated in dashed lines for reference.

### DESCRIPTION

In the Summary of the Invention above, in the Description and appended Claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm.

In this specification and in the appended claims and drawings, “vehicle”, including grammatical equivalents, singular and plural, is to be understood as a means of transport including, but not limited to, cars, trucks, vans, busses, boats, airplanes, or helicopters.

In this specification and in the appended claims and drawings, “occupant”, including grammatical equivalents, singular and plural, is to be understood as a passenger present in a seat in a vehicle.

In this specification and in the appended claims and drawings, “seat”, including grammatical equivalents, singular and plural, is to be understood as a thing made or used for sitting on including, but not limited to, a seat, divan, bench, or sofa.

In this specification and in the appended claims and drawings, “crash event”, including grammatical equivalents, singular and plural, is to be understood as an event that causes a sudden acceleration, the presence of which imparts a loading condition on the vehicle, seat, and occupant. The term acceleration is intended to encompass any change in speed or direction, and includes the commonly used term “deceleration”.

In this specification and in the appended claims and drawings, “crash event vector”, including grammatical equivalents, singular and plural, is to be understood as the direction of an acceleration force experienced in a crash event. By way of example, and not limitation, crash event vectors in the field of aviation are described in reference to forward, aft, up, down, or side load vectors.

In this specification and in the appended claims and drawings, “airbag”, including grammatical equivalents, singular and plural, is to be understood as a safety device fitted inside a vehicle, consisting of a cushion designed to inflate rapidly in response to a crash event.

The terms “adapted” and “configured” are used interchangeably herein to state that a system or apparatus and machine can perform a certain function and is recited herein to provide guidance to those skilled in the art as to the scope of the claim.

Any element in a claim that does not explicitly state “means for” performing a specified function, or “step for” performing a specific function, is not to be interpreted as a “means” or “step” clause as specified in 35 U.S.C. §112, ¶6. In particular, the use of “step of” in the claims herein is not intended to invoke the provisions of 35 U.S.C. §112, ¶6.

While the specification will conclude with claims defining the features of embodiments of the invention that are regarded as novel, it is believed that the invention will be better understood from a consideration of the following description in conjunction with the figures, in which like reference numerals are carried forward.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein.

The examples used herein are intended merely to facilitate an understanding of ways in which the embodiments herein may be practiced and to further enable those of skill in the art to practice the embodiments herein. Accordingly, the examples should not be construed as limiting the scope of the embodiments herein. Specifically, component names, types, and values, as depicted in the exemplary schematic diagrams, are not intended to limit the scope of the present invention and are presented only as possible embodiments.

For purposes of clarity and simplicity of disclosure, but not of limitation, we describe the various embodiments of the invention in the environmental context of an occupant, or occupants, seated on a side-facing divan, fixedly installed in an aircraft. Each occupant is seated and restrained by conventional means on the side-facing divan where the occupant is facing inboard at an angle between 0 and 180 degrees from forward.

It will be readily understood by those having skill in the art that a three point air belt, such as the one disclosed herein, may also be installed in other aircraft structures (single seats, crew-member jump seats, or other occupant seating apparatus) where it is desirable to provide occupant restraint and protection.

Directional terms, such as forward, aft, inboard, and outboard, are to be construed as their standard meanings as is known in aviation.

The various embodiments of the invention disclosed and described herein are contemplated to be applicable to other types of vehicles as well, regardless of whether for air, land, sea, or space travel. In a similar fashion, while a side-facing divan is described, any other type of occupant seating type and orientation is contemplated to be within the scope and spirit of this disclosure. Similarly, a forward crash impact vector is discussed here, although it is understood that other crash vectors are possible and contemplated.

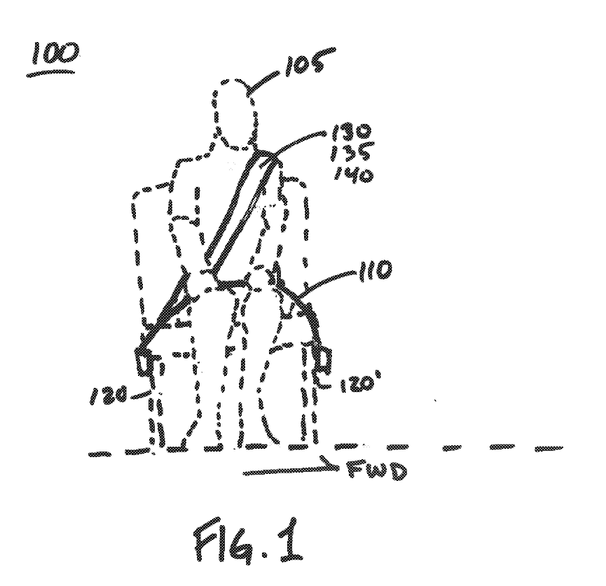

We refer now to the various figures in general, and to FIG. 1 in particular. We discuss here an apparatus 100 for protection of an occupant 105 in an aircraft, the apparatus comprising: a first restraint portion 110 configured to be fixedly attached to an aircraft structure 120, the first restraint portion 110 adapted to restrain the occupant 105 at the occupant's lap; a second restraint portion 130 configured to be fixedly attached to an aircraft structure 120′ and releasably attached to said first restraint portion 110, the second restraint portion 130 configured to restrain the occupant 105 across the occupant's torso and over the occupant's shoulder; and an aviation airbag 135 configured to be disposed in said second restraint portion, where said aviation airbag is optionally compacted by a tubular webbing containment material 140, and said airbag is adapted to conform with vertical flammability requirements of the Federal Aviation Administration while maintaining the high pressure permeability resistance characteristics required for aviation airbags.

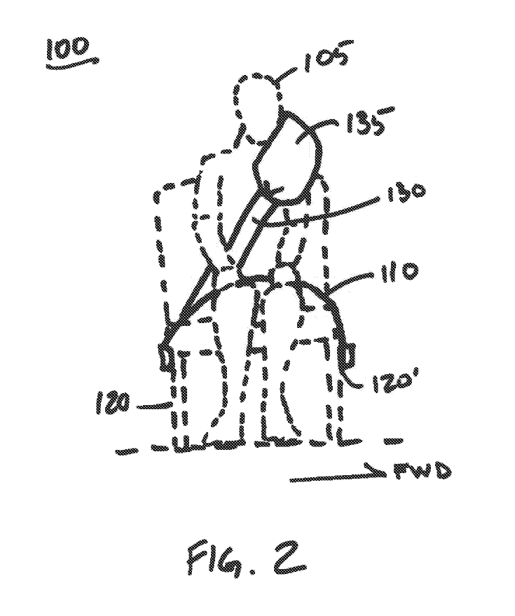

FIG. 2 illustrates the apparatus 100 with the airbag 135 deployed.

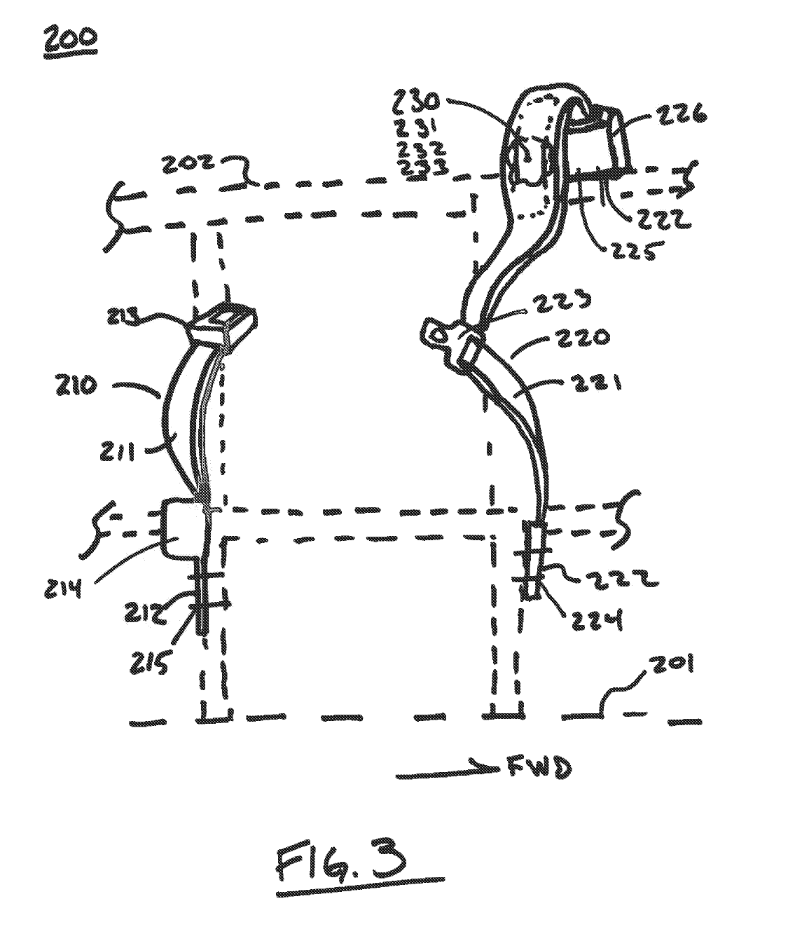

By way of example and not limitation, a preferred embodiment 200 of the present invention is depicted in FIG. 3. An aircraft 201 is outfitted with a side facing divan 202, where the divan structure is fixedly attached to the aircraft structure. The divan 202 will typically have one or more seating positions where the seated occupant faces inboard, perpendicular to aircraft forward. Each seating position of the divan may be configured with one or more seat belt attach points for secure attachment of air belts to the divan structure (which, itself, is securely attached to the aircraft structure) or directly to the aircraft. In a side facing divan, such as described here, there would be at least one air belt attach point on either side of the occupant seating position, at or around the hip level. A third attach point would be located at or around the forward-most shoulder of the seated occupant. It is contemplated to be within the scope of the present invention that this attach point may also be below the seat, on the aircraft structure itself, or in another structurally appropriate location.

A first restraint portion 210 may comprise, for example, a length of webbing 211 configured with attachment hardware 212 at one end and a buckle 213 at the other end. Using the attachment hardware, the first restraint portion may be fixedly attached to a first attach point 215 located generally aft of the occupant, at or around the occupant's hip. The buckle portion would be left accessible to the occupant.

The first restraint portion may further comprise a pretensioner, retractor, or other seat belt tensioning means 214.

A second restraint portion 220 may comprise, for example a length of webbing 221 configured with attachment hardware 222 at both ends, and a buckle mating portion 223 slidingly attached along the webbing between the ends. Using the attachment hardware, the second restraint portion has one end fixedly attached to a second attach point 224 located generally forward of the occupant, at or around the occupant's hip, and the other end fixedly attached to a third attach point 225 located generally forward of the occupant, at or around the occupant's shoulder.

The second restraint portion may further comprise a pretensioner, retractor, or other seat belt tensioning means 226. This seat belt tensioning means may be located at the second attach point, at the third attach point, or at both second and third attach points.

The second restraint portion is further adapted to comprise an airbag system 230 integral to the second restraint portion, and located within the second restraint portion in its un-inflated stated. The integral airbag system is generally disposed within the second restraint portion such that the airbag system is configured to deploy in proximity to the occupant's head. The airbag system generally comprises an airbag 231 compacted so that it is disposed within the second restraint portion and is substantially unobtrusive and comfortable to the occupant. The airbag is a polyester textile treated with a phosphate-phosphonate compound. The airbag may also be coated in a polyurethane mixture. In all cases, the airbag is to conform to FAR 25.853 for vertical flammability.

The compacted airbag may be further contained within the second restraint portion by a tubular webbing 232. Use of this containment material enhances the flexibility of the shoulder harness over the prior art.

The airbag system may also comprise an actuating means 233 as is known in the art for inflating the airbag in an aircraft. Said actuating means configured to pass through the second restraint portion and reach the integral airbag, even though the actual actuator (for example, a gas cartridge) may be external to the system.

Throughout this disclosure, as well as in the appended claims and drawings, where we discuss an airbag or airbag material, we refer specifically to an inflatable bladder that is made out of a flame resistant fabric that not only passes the stringent vertical flammability test performed in accordance with FAR 25.853, but also exhibits the necessary high pressure permeability resistance required for aviation airbags. The invention disclosed herein presents a three-point air belt with integral aviation airbag that, unlike others in the current art, the FAA will not be forced to waive for failure to meet FAR 25.853.

It will be appreciated that the devices, apparatus, and systems described above are set forth by way of example and not of limitation. Numerous variations, additions, omissions, and other modifications will be apparent to one of ordinary skill in the art.

While particular embodiments of the present invention have been shown and described, it will be apparent to those skilled in the art that various changes and modifications in form and details may be made therein without departing from the spirit and scope of the invention as defined by the following claims. The claims that follow are intended to include all such variations and modifications that might fall within their scope, and should be interpreted in the broadest sense allowable by law.

In light of the foregoing description, it should be recognized that embodiments in accordance with the present invention can be realized in numerous configurations contemplated to be within the scope and spirit of the claims. Additionally, the description above is intended by way of example only and is not intended to limit the present invention in any way, except as set forth in the claims.

What is claimed is:

1. An apparatus for protection of an occupant in a vehicle, the apparatus comprising:
a first restraint portion configured to be fixedly attached to a vehicle structure, the first restraint portion adapted to restrain the occupant at the occupant's lap;
a second restraint portion configured to be fixedly attached to a vehicle structure and releasably attached to said first restraint portion, the second restraint portion configured to restrain the occupant across the occupant's torso and over the occupant's shoulder; and
an airbag configured to be disposed in said second restraint portion, where said airbag is adapted to conform with vertical flammability requirements of the Federal Aviation Administration.

2. The apparatus of claim 1, the apparatus further comprising a tubular webbing containment material configured to compact said airbag within said second restraint portion.
